(19) United States
(12) Patent Application Publication
(10) Pub. No.: US 2006/0044629 A1
(43) Pub. Date: Mar. 2, 2006

(54) Image reading device and printing apparatus

(75) Inventor: Takanobu Kono, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/210,752

(22) Filed: Aug. 25, 2005

(30) Foreign Application Priority Data
Aug. 25, 2004 (JP) 2004-244881
Aug. 25, 2004 (JP) 2004244882

(51) Int. Cl. H04N 1/40

(52) U.S. Cl. 358/483; 358/474; 358/448

(57) ABSTRACT

An image reading device that can correctly take in image data is achieved. The image reading device has: (A) a CCD sensor for reading an image; (B) a clock generator that generates a frequency modulated clock; (C) a control circuit that operates in accordance with the frequency modulated clock, controls the CCD sensor, outputs a detection result of the CCD sensor as a data signal, and outputs a take-in clock synchronized with the data signal; and (D) a main circuit that operates in accordance with a separate clock from the frequency modulated clock, to which the data signal and the take-in clock outputted from the control circuit are inputted, and that takes in the data signal based on the take-in clock.

### CROSS-REFERENCE TO RELATED APPLICATIONS

The present application claims priority upon Japanese Patent Application No. 2004-244881 and Japanese Patent Application No. 2004-244882 filed on Aug. 25, 2004, which are herein incorporated by reference.

### BACKGROUND OF THE INVENTION

1. Field of the Invention

The present invention relates to image reading devices and printing apparatuses.

2. Description of the Related Art

Image reading devices that read an image using a CCD sensor are known in the art. These image reading devices are provided with a control circuit that controls the CCD sensor and outputs image data and a main circuit that receives the image data outputted from the control circuit (see, for example, JP 11-187223A).

(1) In controlling the CCD sensor, if the CCD sensor is driven by a drive pulse of a specific frequency, then a strong electromagnetic noise of the specific frequency will be produced in the vicinity of the CCD sensor. In view of this, it is conceivable to suppress the strength of the electromagnetic noise of the specific frequency by controlling the CCD sensor in accordance with a frequency modulated clock.

However, when the control circuit is operated according to a frequency modulated clock and the main circuit is operated according to a separate clock, there is a possibility that the timing will deviate when the main circuit takes in the image data outputted from the control circuit.

(2) Ordinarily, image data is constituted by a plurality of pieces of pixel data respectively corresponding to the pixels in pixel groups arranged in a matrix form. Since the image data is made up of a plurality of pieces of pixel data, when the control circuit outputs the image data to the main circuit, the image data is outputted through a data signal line after the order of the pieces of pixel data has been appropriately switched.

On the other hand, it is necessary for the main circuit to take in, from the data signal line, the signal in which the order of the pixel data is sequentially switched. In view of this, a take-in clock that indicates the take-in timing is outputted from the control circuit to the main circuit. The main circuit will take in the respective pieces of pixel data in accordance with a timing corresponding to the take-in clock.

Here, each piece of pixel data is constituted by R data, G data, and B data. Thus, when the control circuit outputs the image data to the main circuit, the order of the R data, G data, and B data of the respective pixels is switched, and the R data, G data, and B data whose order has been appropriately switched are outputted to the data signal line. In this case, it is necessary for the main circuit to distinguish which color is represented by the signals that have been taken in.

### SUMMARY OF THE INVENTION

A first primary aspect of the present invention for achieving the above-described first issue is an image reading device comprising: a CCD sensor for reading an image; a clock generator that generates a frequency modulated clock; a control circuit that operates in accordance with the frequency modulated clock, controls the CCD sensor, outputs a detection result of the CCD sensor as a data signal, and outputs a take-in clock synchronized with the data signal; and a main circuit that operates in accordance with a separate clock from the frequency modulated clock, to which the data signal and the take-in clock outputted from the control circuit are inputted, and that takes in the data signal based on the take-in clock.

An object of a second aspect of the present invention is to make it possible for the main circuit to take in the respective R data, G data, and B data of each of the pixels using a simple configuration.

A second primary aspect of the present invention for achieving the above-described second issue is an image reading device comprising: a CCD sensor that detects color information on a pixel-by-pixel basis; a control circuit that operates according to a predetermined clock, controls the CCD sensor, switches, in order according to the clock, R data, G data, and B data of each of the pixels based on a detection result of the CCD sensor, and outputs the R data, G data, and B data of each of the pixels to a data signal line, and outputs, to a clock signal line, a take-in clock synchronized with a timing at which the R data, G data, and B data are switched; and a main circuit that operates according to a separate clock from the predetermined clock of the control circuit, and that takes in the R data, the G data, and the B data of each of the pixels from the data signal line at a timing corresponding to the take-in clock of the clock signal line; wherein the control circuit outputs, to the data signal line, an indication signal that indicates a time period in which the R data, the G data, and the B data for a single pixel is outputted; and wherein the main circuit takes in the R data, the G data, and the B data of each of the pixels at a timing corresponding to the indication signal and the take-in clock.

Other features of the present invention will become clear through the description below with reference to the accompanying drawings.

### BRIEF DESCRIPTION OF THE DRAWINGS

FIG. 1 is an overall perspective view of an SPC multifunction apparatus of the present embodiment.

FIG. 2 is a block diagram of a configuration of the SPC multifunction apparatus.

FIG. 3 is an explanatory diagram of a printer section in the SPC multifunction apparatus.

FIG. 4 is an explanatory diagram of a scanner section in the SPC multifunction apparatus.

FIG. 5 is an explanatory diagram of the flow of data during the printer function.

FIG. 6 is an explanatory diagram of the flow of data during the scanner function.

FIG. 7 is an explanatory diagram of the flow of data during the copying function.

FIG. 8 is an explanatory diagram of the configuration of the scanner section.

FIG. 9 is an explanatory diagram of a configuration of a CCD sensor.

FIG. 10 is an explanatory diagram of a first reference example.

FIG. 11 is an explanatory diagram of a second reference example.

FIG. 12 is an explanatory diagram of a third reference example.

FIG. 13 is an explanatory diagram of a configuration of the scanner section of the present embodiment.

FIG. 14 is an explanatory diagram of a configuration of a PLL circuit provided with an SSCG function of the present embodiment.

FIG. 15 is an explanatory diagram of a relationship between image data and a take-in clock.

FIG. 16 is an explanatory diagram of a take-in timing of the image data.

FIG. 17 is an explanatory diagram of a take-in timing for 16-bit image data.

FIG. 18 is an explanatory diagram of signals exchanged between an ASIC and a control circuit.

### DETAILED DESCRIPTION OF THE INVENTION

===Overview of the Disclosure===

At least the following matters will be made clear by the present specification with reference to the accompanying drawings.

An aspect of the present invention is an image reading device comprising: a CCD sensor for reading an image; a clock generator that generates a frequency modulated clock; a control circuit that operates in accordance with the frequency modulated clock, controls the CCD sensor, outputs a detection result of the CCD sensor as a data signal, and outputs a take-in clock synchronized with the data signal; and a main circuit that operates in accordance with a separate clock from the frequency modulated clock, to which the data signal and the take-in clock outputted from the control circuit are inputted, and that takes in the data signal based on the take-in clock.

With this image reading device, it is possible to eliminate deviation in the timing by which the main circuit takes in data signals.

In the above-mentioned image reading device, it is preferable that the clock generator generates the frequency modulated clock in accordance with a reference clock; and an oscillator that generates the reference clock is provided on a same board as the control circuit. In this way, there is no need for a signal line for sending the reference clock to the control circuit.

In the above-mentioned image reading device, it is preferable that the clock generator generates the frequency modulated clock in accordance with a reference clock; and the reference clock is transmitted from the main circuit to the control circuit. In this way, the number of oscillators can be reduced, and cost reductions can be achieved.

In the above-mentioned image reading device, it is preferable that the separate clock by which the main circuit is operated has a higher frequency than the take-in clock; and the main circuit detects a change in a signal level of the take-in clock and takes in the data signal using, as a reference, a timing at which the signal level of the take-in clock changes. In this way, the data signals can be taken in synchronized with the take-in clock.

In the above-mentioned image reading device, it is preferable that the control circuit outputs, as the data signal, R data, G data, and B data in order within a predetermined time period; and before the control circuit outputs the data signal, the control circuit outputs a signal indicating the predetermined time period using a signal line for outputting the data signal. In this way, the main circuit can identify which color of the image data is represented when the main circuit takes in the image data.

In the above-mentioned image reading device, it is preferable that the take-in clock is outputted during a period from when the signal indicating the predetermined time period is outputted until the data signal is outputted. In this way, the main circuit can continue to identify the predetermined time period even after output of the signal indicating the predetermined time period is stopped.

It is also possible to achieve a printing apparatus comprising: a CCD sensor for reading an image; a clock generator that generates a frequency modulated clock; a control circuit that operates in accordance with the frequency modulated clock, controls the CCD sensor, outputs a detection result of the CCD sensor as a data signal, and outputs a take-in clock synchronized with the data signal; a main circuit that operates in accordance with a separate clock from the frequency modulated clock, to which the data signal and the take-in clock outputted from the control circuit are inputted, and that takes in the data signal based on the take-in clock; and a printing section that prints the image on a medium based on the data signal that has been taken in by the main circuit.

With this printing apparatus, the timing at which the main circuit takes in the data signal will not deviate during copying of an image of an original document.

Another aspect of the present invention is an image reading device comprising: a CCD sensor that detects color information on a pixel-by-pixel basis; a control circuit that operates according to a predetermined clock, controls the CCD sensor, switches, in order according to the clock, R data, G data, and B data of each of the pixels based on a detection result of the CCD sensor, and outputs the R data, G data, and B data of each of the pixels to a data signal line, and outputs, to a clock signal line, a take-in clock synchronized with a timing at which the R data, G data, and B data are switched; and a main circuit that operates according to a separate clock from the predetermined clock of the control circuit, and that takes in the R data, the G data, and the B data of each of the pixels from the data signal line at a timing corresponding to the take-in clock of the clock signal line; wherein the control circuit outputs, to the data signal line, an indication signal that indicates a time period in which the R data, the G data, and the B data for a single pixel is outputted; and wherein the main circuit takes in the R data, the G data, and the B data of each of the pixels at a timing corresponding to the indication signal and the take-in clock.

With this image reading device, it is possible for the main circuit to take in the respective R data, G data, and B data of each of the pixels using a simple configuration.

In the above-mentioned image reading device, it is preferable that the control circuit operates according to a frequency modulated clock; and the R data, G data, and B data and the take-in clock are outputted from the control circuit to the main circuit according to the frequency modulated clock. In this way, electromagnetic noise can be suppressed.

In the above-mentioned image reading device, it is preferable that the image reading device further comprises an oscillator that generates a reference clock, and a clock generator that generates the frequency modulated clock according to the reference clock; and the oscillator and the clock generator are provided on a same board as the control circuit. In this way, there is no need for a signal line for sending the reference clock to the control circuit.

In the above-mentioned image reading device, it is preferable that the image reading device further comprises a clock generator that generates the frequency modulated clock in accordance with a reference clock; the clock generator is provided on a same board as the control circuit; and the reference clock is transmitted from the main circuit to the control circuit. In this way, the number of oscillators can be reduced, and cost reductions can be achieved.

In the above-mentioned image reading device, it is preferable that the take-in clock is outputted during a period from when output of the indication signal is stopped until the R data, G data, and B data are outputted. In this way, the main circuit can continue to identify the single pixel period.

In the above-mentioned image reading device, it is preferable that a phase matching signal is outputted from the main circuit to the control circuit; the indication signal and the take-in clock are outputted from the control circuit to the main circuit according to the phase matching signal; the take-in clock is outputted from the control circuit to the main circuit during a period from when output of the indication signal is stopped until the R data, G data, and B data are outputted; and in accordance with the phase matching signal, control of the CCD sensor is started and the R data, G data, and B data are outputted from the control circuit to the main circuit. In this way, the main circuit can identify which image data indicating which color is being transmitted at which timing.

It is also possible to achieve a printing apparatus comprising: a CCD sensor that detects color information on a pixel-by-pixel basis; a control circuit that operates according to a predetermined clock, controls the CCD sensor, switches, in order according to the clock, R data, G data, and B data of each of the pixels based on a detection result of the CCD sensor, and outputs the R data, G data, and B data of each of the pixels to a data signal line, and outputs, to a clock signal line, a take-in clock synchronized with a timing at which the R data, G data, and B data are switched; a main circuit that operates according to a separate clock from the predetermined clock of the control circuit, and that takes in the R data, the G data, and the B data of each of the pixels from the data signal line at a timing corresponding to the take-in clock of the clock signal line; and a printing section that prints, on a medium, an image that has been detected by the CCD sensor, based on the R data, G data, and B data that have been taken in by the main circuit; wherein the control circuit outputs, to the data signal line, an indication signal that indicates a time period in which the R data, the G data, and the B data for a single pixel is outputted; and wherein the main circuit takes in the R data, the G data, and the B data of each of the pixels at a timing corresponding to the indication signal and the take-in clock.

With this printing apparatus, it is possible for the main circuit to take in the respective R data, G data, and B data of each of the pixels using a simple configuration.

===Configuration of Printing System===

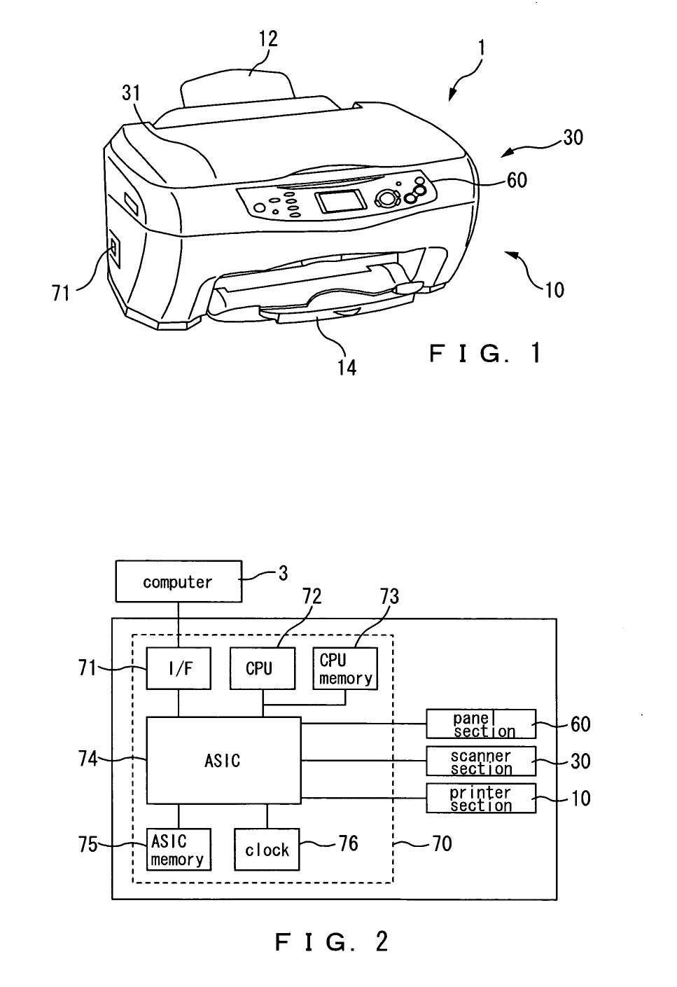

FIG. 1 is an overall perspective view of an SPC multifunction apparatus of the present embodiment. FIG. 2 is a block diagram of a configuration of the SPC multifunction apparatus. An SPC multifunction apparatus 1 of the present embodiment is a multifunction apparatus that has a scanner function for reading an image from an original document, a printer function for printing an image on paper based on print data from an external computer, and a copy function for printing onto paper an image that has been inputted by the scanner function.

The SPC multifunction apparatus 1 has a printer section 10, a scanner section 30, a panel section 60, and a controller 70. Principle structural elements of the printer section 10 are provided in a lower portion of the SPC multifunction apparatus 1. The scanner section 30 is provided above the printer section 10. The panel section 60 is provided on a front surface of the SPC multifunction apparatus 1 to facilitate operation by a user.

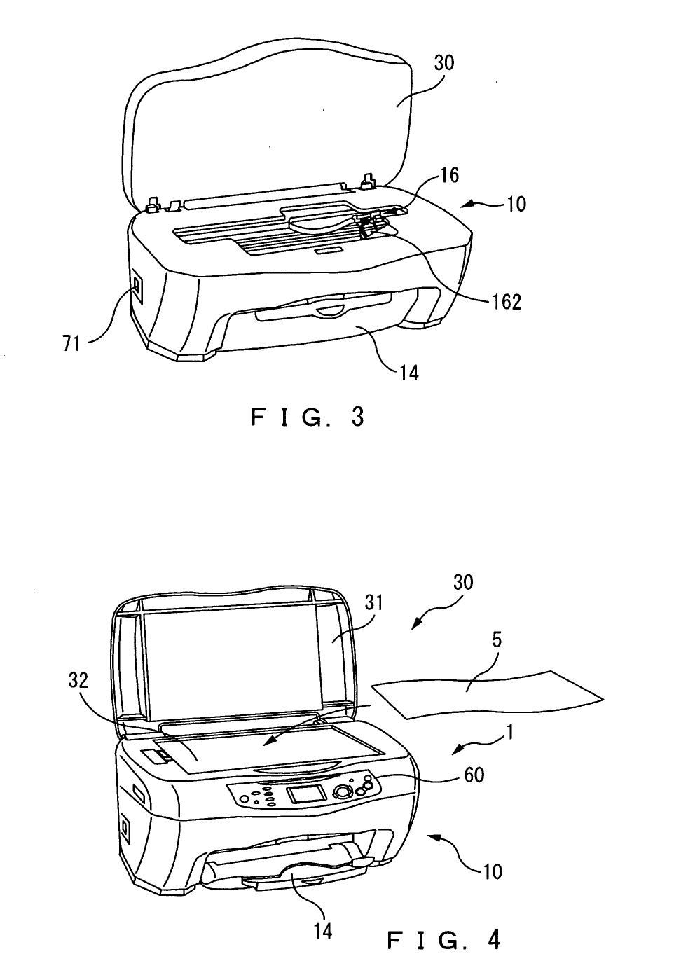

FIG. 3 is an explanatory diagram of the printer section 10 in the SPC multifunction apparatus 1. The printer section 10 has a carry unit (not shown) that carries paper, and a carriage 16 for moving a head that ejects ink. The printer section 10 carries out printing on paper using a so-called inkjet mode by repeating in alternation a carrying operation using the carry unit and a dot formation operation in which ink is ejected from the moving head. The not-shown carry unit supplies paper that has been loaded in a paper supply section 12 in a rear surface of the SPC multifunction apparatus 1 and discharges paper that has been printed to a paper discharge section 14 provided in the front surface of the SPC multifunction apparatus 1. By lifting the scanner section 30 arranged in the upper part of the SPC multifunction apparatus 1, the carriage 16 of the printer section 10 becomes exposed and it becomes possible to replace an ink cartridge 162 that is loaded on the carriage.

FIG. 4 is an explanatory diagram of the scanner section 30 in the SPC multifunction apparatus 1. The scanner section 30 has an upper lid 31 and a mounting glass 32. By closing the upper lid 31 when an original document 5 is placed on the mounting glass 32, the original document 5 is pressed against the mounting glass 32 to make the original document flat and the original document 5 becomes set in the scanner section 30. It should be noted that the principle configuration of the scanner section 30 is described in detail later.

The panel section 60 has a liquid crystal display and various buttons. By pressing the various buttons, the user can input information to the SPC multifunction apparatus 1. For example, by pressing a copy button on the panel section 60, the user can make the SPC multifunction apparatus 1 perform copying.

The controller 70 has an interface section 71, a CPU 72, a CPU memory 73, an ASIC 74, an ASIC memory 75, and a clock 76. The interface section 71 exchanges data with an outside computer 3. The CPU 72 is an arithmetic processing section for carrying out various arithmetic processes. The CPU memory 73 provides an arithmetic area for the CPU 72 or stores a program. The ASIC 74 is a circuit for carrying out specific processing. It should be noted that the specific processing carried out by the ASIC 74 will be described in detail later. The ASIC memory 75 provides an arithmetic area for the ASIC 74. The clock 76 transmits a clock signal for driving the ASIC.

<Regarding the Printer Function>

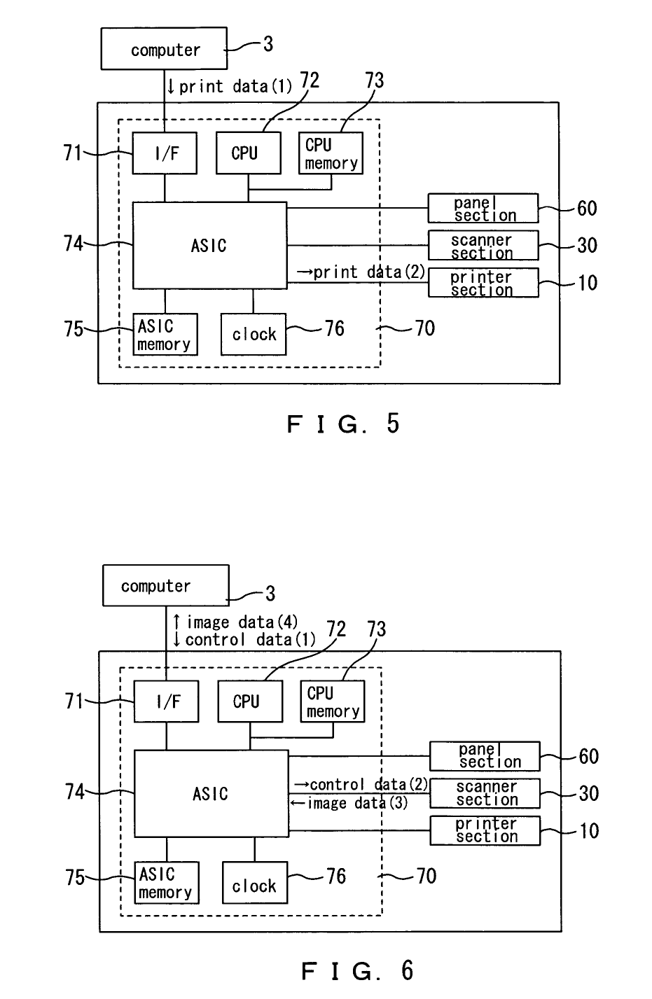

FIG. 5 is an explanatory diagram of the flow of data during the printer function.

A printer driver for the SPC multifunction apparatus 1 is installed in advance on the computer 3. The printer driver causes the computer 3 to convert image data created with an application into print data. The print data includes command data and pixel data. Command data is data for controlling the printer section of the SPC multifunction apparatus 1. Pixel data is data related to the presence/absence, color, and gradation of the dots that constitute a print image. The printer driver makes the computer send the print data to the SPC multifunction apparatus 1.

The ASIC 74 separates the print data received from the computer 3 into command data and pixel data for buffering in the ASIC memory 75. The ASIC 74 then carries out printing by controlling the printer section 10 according to the received command data and causing ejection of ink from the head according to the pixel data. In this way, the SPC multifunction apparatus functions as a printer that prints an image on paper according to print data sent from an external computer.

<Regard the Scanner Function>

FIG. 6 is an explanatory diagram of the flow of data during the scanner function.

A scanner driver for the SPC multifunction apparatus 1 is installed in advance on the computer 3. The user sets the original document 5 on the scanner section 30 in advance. The user then carries out the settings of the scanner driver on the computer 3, adjusting such settings as the reading resolution for example, as well as settings for monochrome or color and the range of reading.

When the user instructs that scanning is to be started using the scanner driver on the computer, the scanner driver causes the computer 3 to transmit control data to the SPC multifunction apparatus 1 according to the settings made by the user.

The ASIC 74 controls the scanner section 30 according to the received control data and obtains image data of the original document 5 from the scanner section 30. The ASIC 74 then sends the obtained image data to the computer 3. In this way, the SPC multifunction apparatus 1 functions as a scanner that reads an image of the original document 5.

<Regarding the Copying Function>

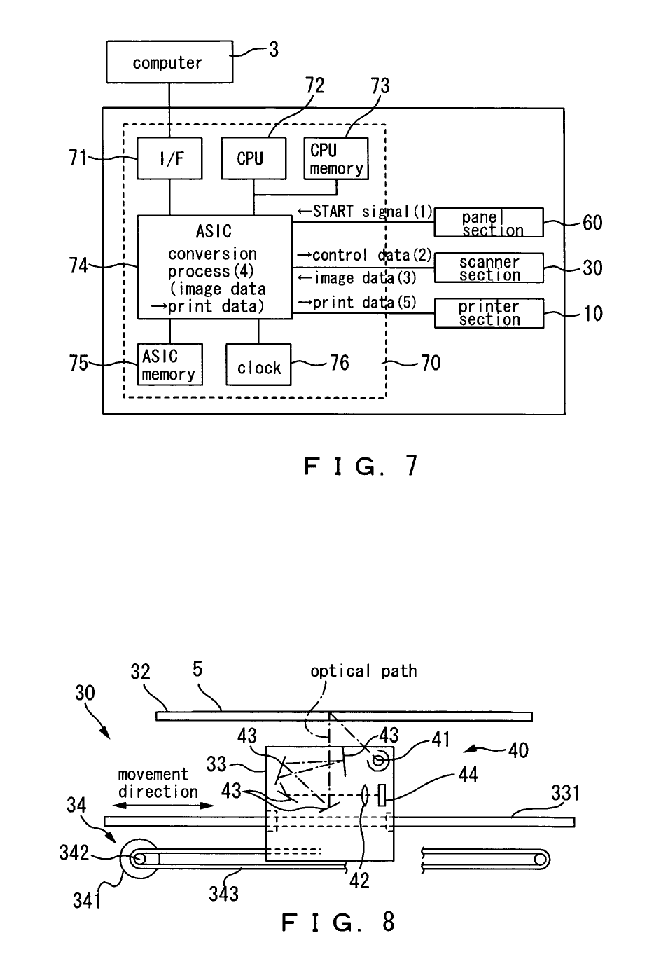

FIG. 7 is an explanatory diagram of the flow of data during the copying function.

The user sets the original document 5 on the scanner section 30 in advance. The user then operates the panel section 60 to carry out settings such as paper size, original document size, magnification, and copy mode (fast/fine).

When the user presses the copy button on the panel section 60, a START signal indicating that printing is to be started is sent from the panel section 60 to the ASIC 74. The ASIC 74 controls the scanner section 30 according to the control data, which corresponds to the user settings, and obtains image data of the original document 5 from the scanner section 30. The ASIC 74 buffers the image data from the scanner section 30 in the ASIC memory 75.

The image data from the scanner section 30 is RGB (red, green, blue) data of 256 gradations for example. The ASIC 74 converts (color converts) this data to CMYK (cyan, magenta, yellow, black) data of 256 gradations. It should be noted that a color conversion table necessary for color conversion is stored in the ASIC memory 75. Next, the ASIC 74 converts (performs halftoning on) the CMYK data of 256 gradations to CMYK data of two gradations. This CMYK data of two gradations constitutes pixel data of the print data. It should be noted that a dot generation ratio table for converting the data of 256 gradations to data of two gradations is also stored in the ASIC memory 75.

When the image data from the scanner is to be magnified or reduced, the CPU 72 processes the image data that is in the ASIC memory 75, and the ASIC 74 performs color conversion and/or halftoning based on the processed image data.

Once the image data is converted to print data by the ASIC 74, the SPC multifunction apparatus 1 carries out printing by controlling the printer section 10 according to the print data. In this way, the SPC multifunction apparatus 1 functions as a copier.

===Configuration of the Scanner Section 30===

<Regarding the Overall Configuration of the Scanner Section 30>

FIG. 8 is an explanatory diagram of the configuration of the scanner section 30. In addition to the upper lid 31 and the mounting glass 32, the scanner section 30 is further provided with a reading carriage 33, a drive unit 34, and a sensor unit 40.

The reading carriage 33 can be moved along a guide 331 in a movement direction. The sensor unit 40 is accommodated in the reading carriage 33.

The drive unit 34 has a drive motor 341, a pulley 342, and a timing belt 343. When the drive motor 341 drives, the pulley 342 is rotated such that the timing belt also rotates. A portion of the timing belt is joined to the reading carriage 33 and when the timing belt 343 rotates, the reading carriage 33 moves along the guide 331 in the movement direction.

The sensor unit 40 has a light source 41, a lens 42, mirrors 43, and a CCD sensor 44. The light source 41 irradiates light onto the original document 5. The lens 42 focuses reflected light from the original document 5 onto the CCD sensor 44. The mirrors 43 are for extending the optical path so that the lens 42 can focus the reflected light from the original document 5 onto the CCD sensor 44. The CCD sensor 44 outputs signals corresponding to the received light.

The sensor unit 40 reads, from the original document 5, images in units of line-shaped regions each being long in a direction perpendicular to the paper plane on which FIG. 8 is depicted. By the reading carriage 33 moving the sensor unit 40 in the movement direction, the scanner section 30 can read the overall image on the original document 5.

<Regarding the Configuration of the CCD Sensor>

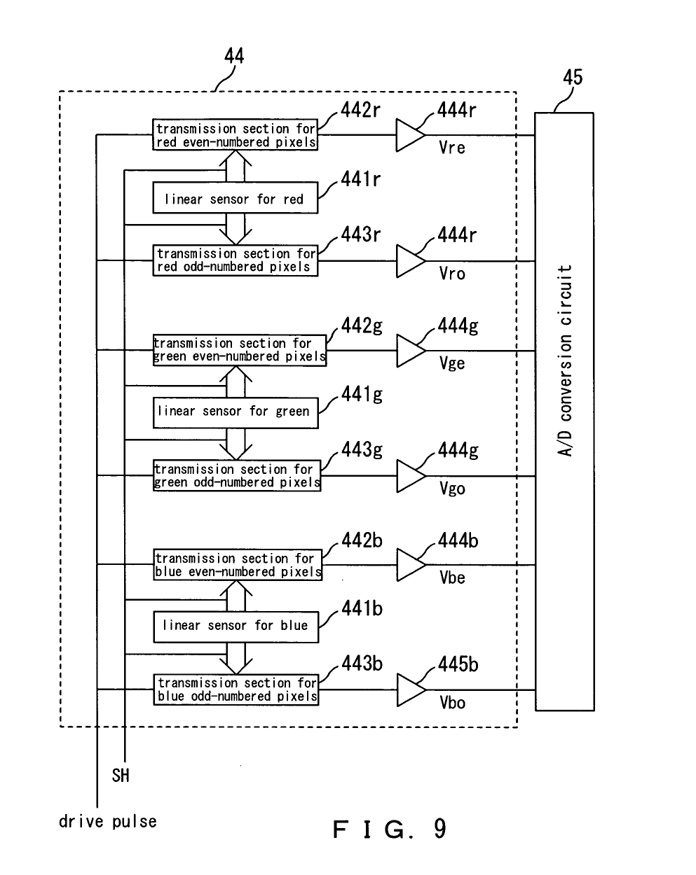

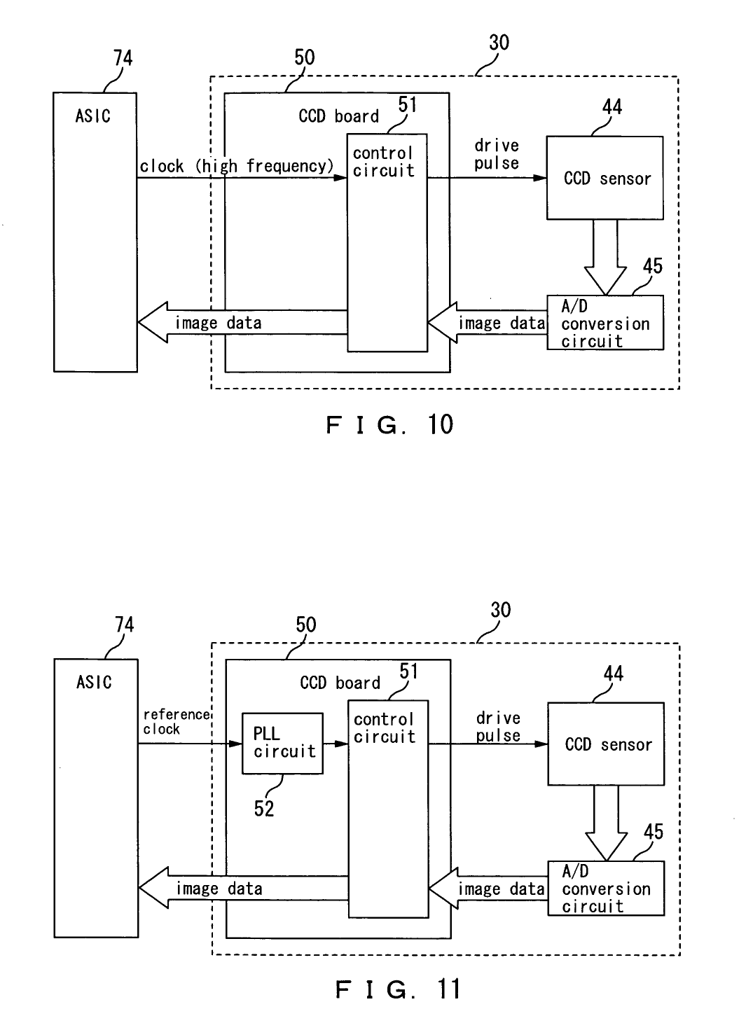

FIG. 9 is an explanatory diagram of the configuration of the CCD sensor 44.

The CCD sensor 44 has three linear sensors 441r, 441g, and 441b in which light-receiving elements (photodiodes for example) that convert light to electrical signals are arranged in a row, and these three linear sensors 441r, 441g, and 441b are arranged parallel to a direction perpendicular to the movement direction. A different color filter is provided for each of the linear sensors 441 so that each of the linear sensors 441 respectively detects light of a different color. For example, the linear sensor 441r for red is provided with a red filter and detects the intensity of red light. The following description focuses on the linear sensor 441r for red that detects red light, but the linear sensor 441g for green that detects green light and the linear sensor 441b for blue that detects blue light are configured in a similar manner.

The light-receiving elements of the linear sensor 44lr receive light for a single pixel period and accumulates an electric charge. When a shift signal SH is inputted to the linear sensor 441r, the electric charges of light-receiving elements corresponding to even-numbered pixels are transmitted to a transmission section 442r for even-numbered pixels and the electric charges of light-receiving elements corresponding to odd-numbered pixels are transmitted to a transmission section 443r for odd-numbered pixels. Then, when a drive pulse is inputted to the transmission section 442r for even-numbered pixels, the transmission section 442r for even-numbered pixels, which is a shift register, horizontally transfers the electric charges, and the transferred charges undergo voltage transduction at an amplifier 444r and a voltage signal Vre is outputted. Similarly, when a drive pulse is inputted to the transmission section 443r for odd-numbered pixels, the transmission section 443r for odd-numbered pixels, which is a shift register, horizontally transfers the electric charges, and the transferred charges undergo voltage transduction at an amplifier 445r and a voltage signal Vro is outputted.

The voltage signal (analog signal) that is outputted from the CCD sensor 44 undergoes analog/digital conversion at an A/D conversion circuit 45 to become data (image data) that represents RGB gradations of each pixel.

It should be noted that the drive pulses that are inputted to the transmission section 442r for even-numbered pixels and the transmission section 443r for odd-numbered pixels are high frequency signals since it is necessary for the horizontal transfer of the shift registers to be carried out at high speed.

Note here that with the configuration of the CCD sensor 44 shown in FIG. 9, there are six lines of analog output, but it goes without saying that a configuration in which there are three lines of analog output is also possible.

### EXAMPLES FOR REFERENCE

### First Reference Example

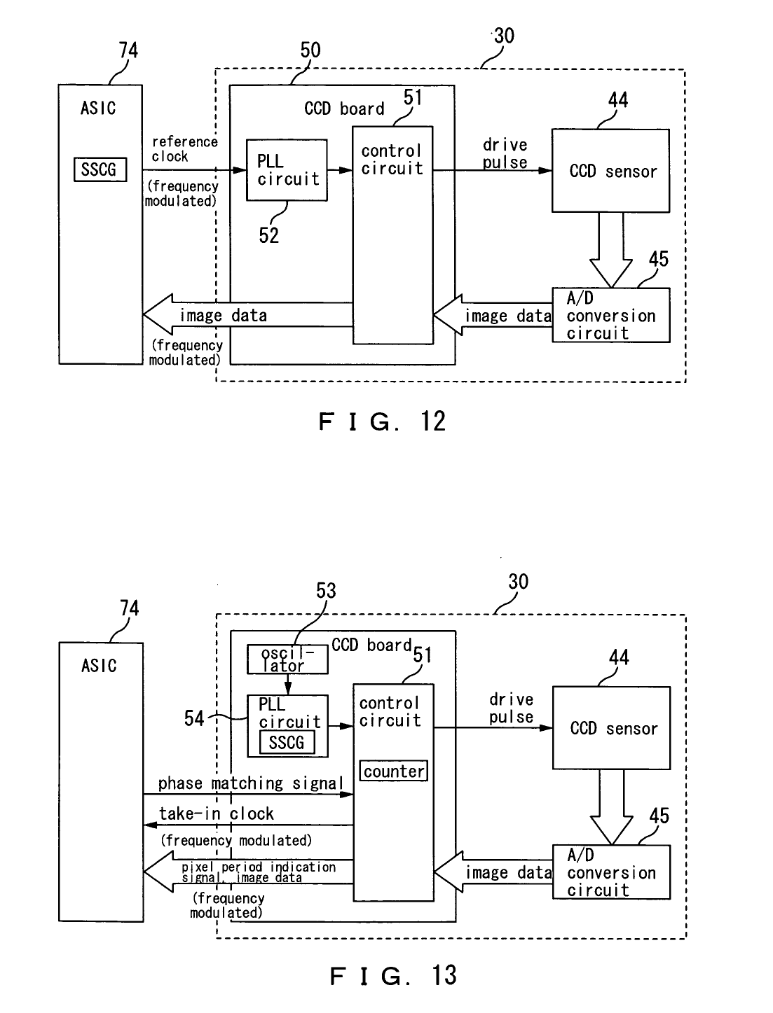

FIG. 10 is an explanatory diagram of the first reference example.

A CCD board 50 is contained in the scanner section 30. Provided in the CCD board 50 is a control circuit 51 for carrying out control of the CCD sensor 44 and the drive motor 341. The CCD board 50 is a separate board from the ASIC 74, and therefore a signal line is provided for exchanging signals between the CCD board 50 and the ASIC 74. Shown in the drawing are a clock signal line for exchanging clock signals and a data signal line for exchanging image data. It should be noted that there is one clock signal line for exchanging clock signals and eight data signal lines for exchanging image data.

In the first reference example, a high frequency clock signal for driving the CCD board and the CCD sensor 44 is transmitted from the ASIC 74 to the CCD board 50. In this configuration, strong electromagnetic noise is produced at the frequency of the clock signal around the clock signal line between the ASIC 74 and the CCD board 50.

Furthermore, in the first reference example, since the drive pulse that is inputted to the CCD sensor 44 also has a high frequency, strong electromagnetic noise is also produced at the frequency of the drive pulse around the CCD sensor 44.

### <Second Reference Example>

FIG. 11 is an explanatory diagram of the second reference example.

In the second reference example, the CCD board 50 is provided with a PLL circuit 52. The PLL circuit 52 multiplies a reference clock signal transmitted from the ASIC 74 and outputs a high frequency clock signal synchronized with the phase of the reference clock to the control circuit 51. In the second reference example, the frequency of the clock signal that is transmitted from the ASIC 74 to the CCD board 50 can be lowered.

However, in the second reference example, since the drive pulse that is inputted to the CCD sensor 44 has a high frequency as in the first reference example, strong electromagnetic noise is produced at the frequency of the drive pulse around the CCD sensor 44.

### <Third Reference Example>

In both the first and second reference examples, electromagnetic noise of a specific frequency is produced around the CCD sensor 44. However, when such electromagnetic noise is produced, it is not possible to meet the EMI standards stipulated in various countries.

A frequency modulation device called an SSCG (spread spectrum clock generator) is sometimes used as a countermeasure against electromagnetic noise. The strong electromagnetic noise is produced by a clock signal of a high single frequency. An SSCG is able to modulate the clock signal so that the electromagnetic noise of the specific frequency does not become high.

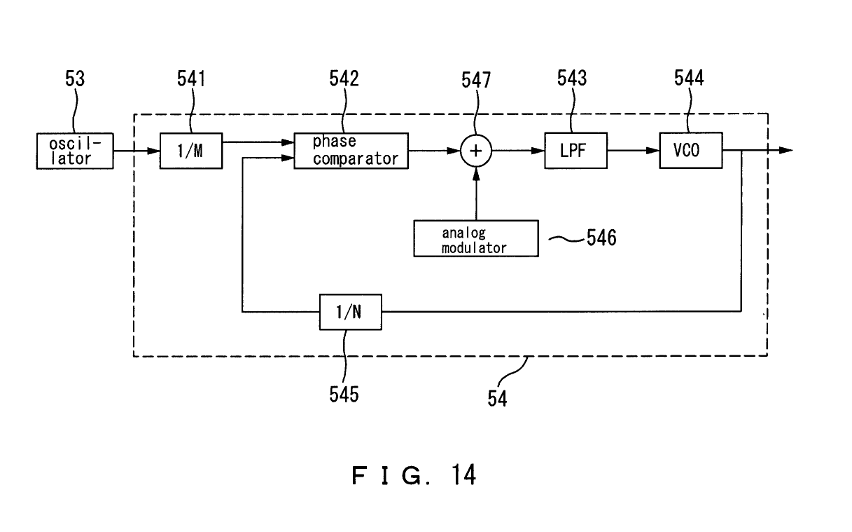

FIG. 12 is an explanatory diagram of a third reference example.

In the third reference example, an SSCG is provided in the ASIC 74, and the reference clock transmitted from the ASIC 74 to the CCD board 50 is modulated. In this way, since the drive pulse that is inputted to the CCD sensor 44 is also modulated, the electromagnetic noise of the specific frequency does not become high,around the CCD sensor 44.

However, when attempting to multiply the modulated clock signal as the reference clock at the PLL circuit, the PLL circuit becomes unstable.

In the embodiment that will be described below, the SSCG is provided on the CCD board 50 side. However, when using such a configuration, the frequency of the image data transmitted from the CCD board 50 to the ASIC 74 is also modulated, thus causing a problem in the timing at which the ASIC 74 takes in the image data. This issue is also solved in the embodiment that will be described below.

### ===Configuration of the Scanner Section 30 of the Present Embodiment===

<Overview>

FIG. 13 is an explanatory diagram of the configuration of the scanner section 30 of the present embodiment. The CCD board 50 of the scanner section 30 of the present embodiment is provided with the control circuit 51, an oscillator 53, and a PLL circuit 54 that has an SSCG function.

The control circuit 51 transmits signals such as drive pulses and shift signals SH (see FIG. 9) to the CCD sensor 44 to control the CCD sensor 44. Furthermore, although not shown in FIG. 13, the control circuit 51 also controls the drive of the drive motor 341. These controls are carried out by the control circuit 51 according to the control data transmitted from the ASIC 74 to the scanner section 30.

The oscillator 53 generates a clock signal of a constant frequency. Note however that the clock signal generated by the oscillator 53 has a comparatively low frequency, and therefore does not present a problem of electromagnetic noise. The clock signal that is outputted from the oscillator 53 is inputted to the PLL circuit 54.

The PLL circuit 54 also has an SSCG function. That is, in addition to multiplying the reference clock from the oscillator 53, the PLL circuit 54 of the present embodiment also outputs a modulated clock signal to the control circuit 51.

In this way, the control circuit 51 is driven by the modulated clock signal, and therefore the drive pulse that the control circuit 51 outputs to the CCD sensor 44 is also modulated. As a result, the strength of the specific frequency is low even when the frequency of the drive pulse is high, and therefore the electromagnetic noise produced in the vicinity of the CCD sensor 44 can also be reduced.

Note however that the voltage signal that is outputted from the CCD sensor 44 to the A/D conversion circuit and the image data outputted from the A/D conversion circuit to the control circuit 51 are also modulated. Further, since the control circuit 51 is driven by the modulated clock signal, the image data that is transmitted from the control circuit 51 to the ASIC 74 is also modulated.

In the present embodiment, frequency modulation is carried out on the CCD board 50 side, and therefore the ASIC 74 is not operated according to a modulated clock. Furthermore, there are also cases in which the ASIC 74 is operated on a modulated clock separate from the modulated clock of the control circuit 51. Thus, the clock that drives the ASIC 74 is not synchronized with the clock that drives the control circuit 51, and therefore, if the image data is simply sent to the ASIC 74, there is a possibility that the timing will deviate when the ASIC 74 takes in the image data.

In view of the above, in the present embodiment, a take-in clock signal is outputted from the control circuit 51 to the ASIC 74. The take-in clock signal is a clock signal synchronized with the image data. In the present embodiment, the ASIC 74 takes in modulated image data according to the timing of the rising edge (or the timing of the falling edge) of the take-in clock signal.

Here, the R data, G data, and B data of the image data are switched in order and transmitted. Thus, it is necessary for the ASIC 74 to distinguish which color is represented by the data being taken in. Accordingly, in the present embodiment, before the image data is outputted to the data signal line, the control circuit 51 outputs a “pixel period indication signal” to the data signal line so that the ASIC 74 can identify the period for a single pixel.

### <Regarding the Configuration of the PLL Circuit 54 of the Present Embodiment>

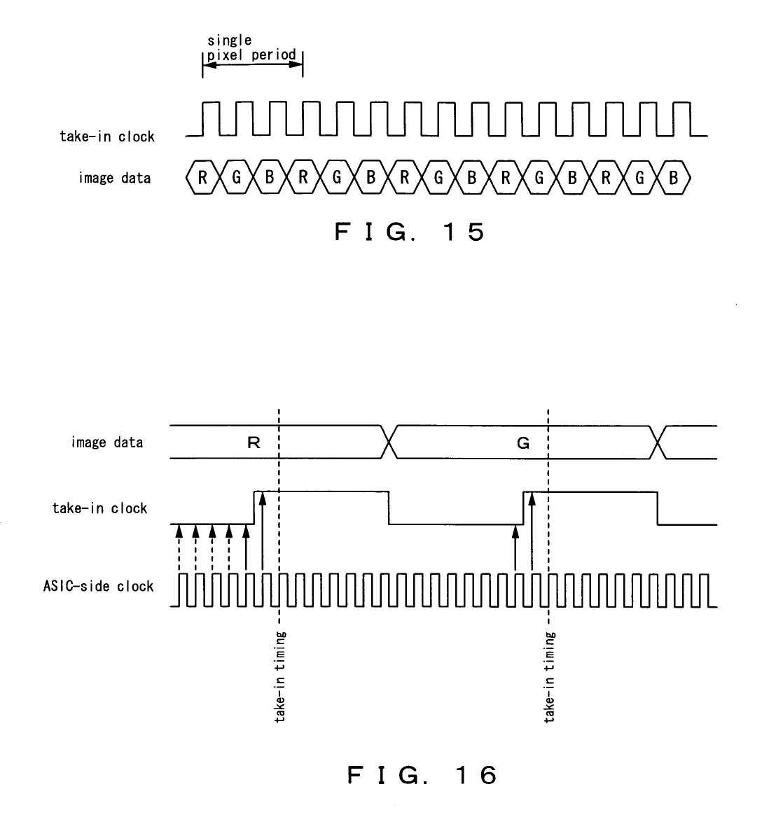

FIG. 14 is an explanatory diagram of a configuration of the PLL circuit 54 provided with an SSCG function of this embodiment ordinarily, a PLL circuit has a 1/M frequency divider 541, a phase comparator 542, a loop filter (LPF) 543, a voltage controlled oscillator (VCO) 544, and a 1/N frequency divider 545. The 1/M frequency divider 541 divides the frequency of the reference clock from the oscillator 53 and gives an output to the phase comparator 542. The phase comparator 542 compares the phases of the two input signals and generates a pulse signal if the edges of the signals are different. The loop filter 543 blocks the high frequency component in the signal from the phase comparator and outputs a DC signal with a small AC component. The voltage controlled oscillator 544 regulates the oscillation frequency according to the DC signal that is inputted. The 1/N frequency divider 545 divides the frequency of the output signal from the voltage controlled oscillator 544 and gives an output to the phase comparator 542. In the PLL circuit, if the phase of the output signal of the voltage controlled oscillator 544 is ahead, then the oscillation frequency is lowered to slow the phase, and if the phase of the output signal of the voltage controlled oscillator 544 is lagging, then the oscillation frequency is raised to advance the phase, so that the reference signal that is inputted from the 1/N frequency divider and the output signal are synchronized. With this PLL circuit, a clock signal can be obtained that has a frequency N÷M times the reference clock.

In the PLL circuit 54 of the present embodiment, a voltage adder 547 that adds the voltage from an analog modulator 546 is provided between the phase comparator 542 and the loop filter 543. This modulates the clock signal that is outputted from the PLL circuit 54. Specifically, the frequency is modulated within a range of ±1.5%.

In the present embodiment, the frequency modulated clock from the PLL circuit 54 is inputted to the control circuit 51, and the control circuit 51 is operated according to this frequency modulated clock. That is, the control circuit 51 outputs the shift signal SH and the drive pulse (see FIG. 9) to the CCD sensor 44 according to the frequency modulated clock to control the CCD sensor 44. At this time, the drive pulse signal that is sent from the control circuit 51 to the CCD sensor 44 is also frequency modulated, and therefore the peak strength of the electromagnetic noise of a specific frequency can be reduced in the vicinity of the CCD sensor.

<Regarding the Taking In of Image Data—1>

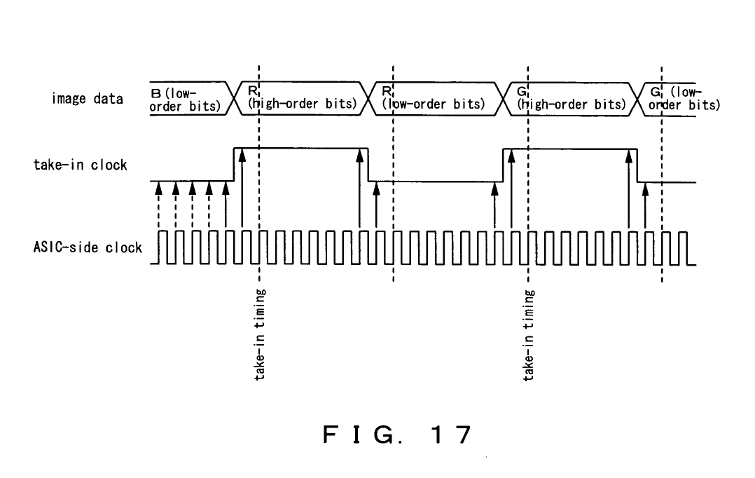

FIG. 15 is an explanatory diagram of the relationship between the image data and the take-in clock.

Image data is transmitted from the control circuit 51 to the ASIC 74 via eight data signal lines. The R data, G data, and B data of the image data are switched in order and transmitted. Transmitting one group of R data, G data, and B data achieves the transmission of image data (pixel data) for a single pixel. In a single line there are a multitude of pixels lined up in a row, so R data, G data, and B data are transmitted in repetition in order to transmit one line portion of image data. Although not evident in the drawing, in the present embodiment, the frequency by which the R data, G data, and B data are switched in order is modulated by the SSCG within the range of ±1.5%.

Although not evident in the drawing, the take-in clock signal is also modulated by the SSCG within the range of ±1.5%. However, the take-in clock signal is synchronized with the frequency by which the image data is switched. Thus, it is ensured that a piece of data (color data) of one of the R data, G data and B data is being transmitted at the timing of the rising pulse of the take-in clock signal.

FIG. 16 is an explanatory diagram of the take-in timing of the image data. For convenience, the time axis in FIG. 16 is made larger than the time axis in FIG. 15. The ASIC-side clock in the lower section of FIG. 16 is a clock for operating the ASIC 74 and is a signal generated by the clock 76 of FIG. 2. In contrast to the take-in clock being approximately 6 MHz (that is, modulated within approximately ±1.5%), the ASIC-side clock is 96 MHz.

The ASIC 74 monitors the signal level of the take-in clock using the timing of the rising pulse of the ASIC-side clock. Then, after the ASIC 74 has detected that the signal level of the take-in clock has changed from an L level to an H level, the ASIC 74 takes in image data with the timing of the next rising pulse of the ASIC-side clock.

Specifically, in the drawing, the ASIC 74 detects that the signal level of the take-in clock is at the L level at the fifth rising pulse of the ASIC-side clock, and then detects that the signal level of the take-in clock is at the H level at the following sixth rising pulse of the ASIC-side clock. Accordingly, at the seventh rising pulse of the ASIC-side clock, the ASIC 74 detects the signal levels of the eight data signal lines that convey image data and takes in the 8-bit information at this timing as image data.

In the present embodiment, the control circuit 51 is operated by the clock that is frequency modulated by the PLL circuit 54, and the ASIC 74 is operated by the clock (ASIC-side clock) from the clock 76. The clock that is frequency modulated by the PLL circuit 54 and the ASIC-side clock are not synchronized, and therefore there is a possibility that the timing will deviate when the ASIC 74 takes in the image data if the image data is transmitted in order with this modulated frequency.

In the present embodiment, a take-in clock signal used as the reference for the take-in timing is sent from the control circuit 51 to the ASIC 74. The take-in clock signal is frequency modulated since it is outputted from the control circuit 51, but it is a signal that is synchronized with the image data. The ASIC 74 then monitors changes in the signal level of the take-in clock and takes in image data using the timing at which the signal level changes as a reference. In this way, even if the operational clock of the ASIC 74 and the operational clock of the control circuit 51 are not synchronized, the ASIC 74 can take in image data from the control circuit 51 without any deviation in timing.

Here, the R data, G data, and B data of the image data are switched in order and transmitted. Thus, it is necessary for the ASIC 74 to identify the color of the image data while the image data is being taken in. For example, in FIG. 16, it is necessary for the ASIC 74 to identify which color is represented by the image data being transmitted at the time of the seventh rising pulse of the ASIC-side clock.

Accordingly, when taking in one line portion of image data, a phase matching signal is transmitted from the ASIC 74 to the control circuit 51 and a pixel period indication signal for indicating a single pixel period is transmitted from the control circuit 51 to the ASIC 74 according to the phase matching signal. This will be described in detail later.

<Regarding the Taking In of Image Data—2>

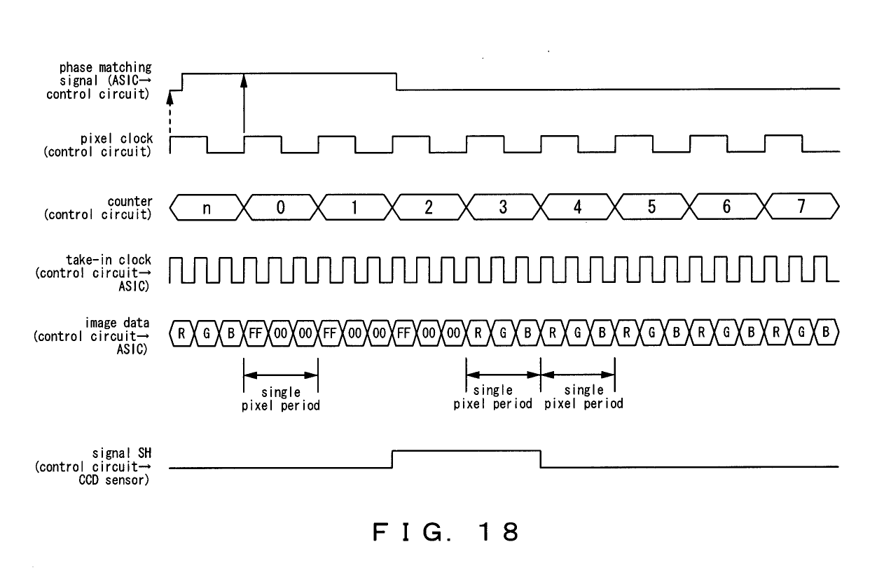

FIG. 17 is an explanatory diagram of a different take-in timing of the image data. When comparing FIG. 17 and FIG. 16, the take-in clocks and the ASIC-side clocks are the same. Regarding the image data, the image data in FIG. 16 is 8-bit information, but the image data in FIG. 17 is 16-bit information. Thus, the image data in FIG. 16 was switched at the timing of the falling pulse of the take-in clock, but the image data in FIG. 17 is switched at both the rising pulse and the falling pulse of the take-in clock.

The control circuit 51 transmits the 8 high-order bits of the 16-bit R data at the timing of the rising pulses of the take-in clock. After detecting that the signal level of the take-in clock has changed from an L level to an H level, the ASIC 74 takes in the 8 high-order bits of the R data. After this, the control circuit 51 transmits the 8 low-order bits of the 16-bit R data with the timing of the falling pulse of the take-in clock. After detecting that the signal level of the take-in clock has changed from the H level to the L level, the ASIC 74 takes in the 8 low-order bits of the R data. In this way, the ASIC 74 is capable of taking in 16-bit image data from the eight signal lines.

Note that the image data is 16-bit data in the following description. However, the signal switchover from high-order bits to low-order bits is not shown in order to simplify the drawings.

<Regarding the Taking In of One Line Portion of Image Data>

FIG. 18 is an explanatory diagram of signals exchanged between the ASIC 74 and the control circuit 51 (note that the signal SH is not a signal that is exchanged between the ASIC 74 and the control circuit 51 but rather is a signal that is transmitted from the control circuit 51 to the CCD sensor 44).

Initially, the ASIC 74 and the control circuit 51 are operated based on different clock signals. While in this state, a phase matching signal is transmitted from the ASIC 74 to the control circuit 51.

The phase matching signal is transmitted from the ASIC 74 to the control circuit 51 through a different signal line from the eight signal lines for transmitting image data and the signal line for transmitting the take-in clock. It is assumed in this example that the phase matching signal has been transmitted when the signal level of the phase matching signal is switched from L to H.

The control circuit 51 is operated based on an internal pixel clock. The control circuit 51 detects the phase matching signal at the timing of the rising pulse of the pixel clock. When the detected signal level switches from L to H, the control circuit 51 resets a counter that is provided internally. The control circuit 51 then increases the counter value in increments of one for each rising pulse of the pixel clock. It should be noted that a one-clock period of the pixel clock corresponds to a period of three pulses of the take-in clock. That is, one clock of the pixel clock represents a single pixel period.

Once it has been detected that the signal level of the phase matching signal has switched from L to H, the control circuit 51 transmits the pixel period indication signal to the ASIC 74 using the eight signal lines by which image data is transmitted. As shown in the drawing, the pixel period indication signal is a signal that is switched at timings synchronized with the take-in clock in the order “FF (all 16-bit data are 1)”→“00 (all 16-bit data are 0)”→“00”→“FF”→“00”→“00”. By receiving the pixel period indication signal, the ASIC 74 can identify the period for a single pixel.

After this, the ASIC 74 switches the signal level of the phase matching signal from H to L. When the control circuit 51 detects that the signal level of the phase matching signal has changed from L to H, the control circuit 51 stops transmitting the pixel period indication signal. However, since the take-in clock signal continues to be transmitted from the control circuit 51 to the ASIC 74, the ASIC 74 continues to be able to identify the one-pixel period.

Using the count value of the counter as a reference, the control circuit 51 controls the CCD sensor 44. For example, when the count value becomes “2,” the control circuit 51 transmits the shift signal SH to the CCD sensor 44. It should be noted that the count value “2” for transmitting the shift signal SH is a value that is set in a register of the control circuit 51 in advance. Thus, after a predetermined timing (in this case, three pixel periods) from the resetting of the counter, the control circuit 51 obtains valid image data from the CCD sensor 44. The control circuit 51 then transmits the valid image data to the ASIC 74 at a predetermined timing (immediately after the transmission of the pixel period indication signal has stopped).

The ASIC 74 takes in image data (pixel data) for a single pixel by taking in the first image data of that pixel period as R data, then taking in the next image data as G data, and further taking in the next image data as B data. Furthermore, the ASIC 74 takes in the image data following the B data as the R data of the next pixel. In this way, the ASIC 74 identifies the one-pixel period based on the pixel period indication signal and the take-in clock, and therefore is able to identify for example the timing by which the R data is being transmitted or by what timing which pixel data is being transmitted.

After the ASIC 74 has taken in one line of image data, the ASIC 74 transmits the phase matching signal at a predetermined timing in order to be able to read the next line of the image. It should be noted that the timing from the transmission of the phase matching signal to the transmission of the next phase matching signal varies according to the storage time of the CCD sensor 44. The storage time changes depending on such factors as the reading resolution, the type of original document, and the brightness of the light source.

### ===Other Embodiments===

The above embodiment was written primarily with regard to an SPC multifunction apparatus, but the above embodiment of course also includes the disclosure of an image reading device (scanner), an image reading method, and so on.

Furthermore, an SPC multifunction apparatus, for example, was described as one embodiment, but the foregoing embodiment is for the purpose of elucidating the present invention and is not to be interpreted as limiting the present invention. The invention can of course be altered and improved without departing from the gist thereof and includes functional equivalents.

### ===SUMMARY===

(1-1) The above-described SPC multifunction apparatus is provided with a CCD sensor 44 for reading an image, a control circuit 51 that controls the CCD sensor 44 and outputs a detection result of the CCD sensor 44 as image data (data signal), and an ASIC 74 (main circuit) to which the image data outputted from the control circuit is inputted.

Here, when the CCD sensor 44 is driven by a drive pulse of a specific frequency, the strength of the electromagnetic noise of the specific frequency becomes high around the CCD sensor 44. Accordingly, in the above-described embodiment, a frequency modulated clock is generated by a PLL circuit 54 that has an SSCG function. The control circuit then operates according to this frequency modulated clock and outputs image data (data signal) to the ASIC 74.

However, the ASIC 74 operates according to a clock separate from the frequency modulated clock. Thus, when the ASIC 74 takes in the image data (data signal) that is outputted from the control circuit 51, there is a possibility that the timing will deviate.

Accordingly, the control circuit 51 outputs to the ASIC 74 a take-in clock that is synchronized with the image data (data signal), and the ASIC 74 (main circuit) takes in image data according to this take-in clock.

In this way, image data can be correctly taken in even when the control circuit 51 and the ASIC 74 are operating on different clocks.

(1-2) In the above-described embodiment, the PLL circuit 54 generates the frequency modulated clock based on a reference clock. The oscillator 53 that generates this reference clock is provided on the same board as the control circuit 51. Thus, there is no need for a signal line for sending the reference clock to the control circuit 51.

(1-3) However, it is not absolutely necessary for the oscillator 53 to be provided on the same board as the control circuit 51. For example, it is also possible that a low frequency reference clock is transmitted from the ASIC 74 to the control circuit 51 and the control circuit 51's PLL circuit, which has an SSCG function, performs multiplication while modulating the reference clock. In this case, although a signal line is necessary for sending the reference clock from the ASIC 74 to the control circuit 51, the oscillator 53 can be omitted, thus enabling costs to be reduced.

(1-4) In the above-described embodiment, the clock for operating the ASIC 74 (main circuit) is 96 MHz and the take-in clock is approximately 6 MHz (frequency modulated to within ±1.5%). The ASIC 74 monitors changes in the signal level of the take-in clock at 96 MHz and after the ASIC 74 has detected that the signal level of the take-in clock has changed from an L level to an H level, the ASIC 74 takes in image data (data signal) with the timing of the next rising pulse of the ASIC-side clock as the reference.

However, the reference for the timing at which image data is taken in is not limited to this. For example, the time at which the signal level of the take-in clock changes from the H level to the L level may be used as the reference.

(1-5) In the above-described embodiment, R data, G data, and B data is outputted as the pixel data and one line of pixel data is outputted continuously. As a result, the R data, G data, and B data are switched in order and outputted. Thus, it is necessary for the ASIC 74 to identify which color of the image data is represented while the image data is being taken in.

Accordingly, in the above-described embodiment, before the control circuit 51 outputs the image data (data signal), the control circuit 51 outputs a pixel period indication signal in order to indicate a period for a single pixel, using the eight signal lines for outputting image data. In this way, the ASIC 74 can identify a single pixel period and therefore is able to identify for example the timing at which the R data is being transmitted or at what timing which pixel data is being transmitted.

(1-6) In the above-described embodiment, when the signal level of the phase matching signal changes to the L level, the pixel period indication signal stops being transmitted. However, since the take-in clock is being outputted during the time from when the pixel period indication signal is stopped until the image data (data signal) are outputted, the ASIC 74 can continue to identify the one-pixel period.

(1-7) If all the structural elements of the above-described embodiment are included, it is possible to achieve all the effects described above. However, it is not absolutely necessary to have all the structural elements to achieve the effect of correctly taking in image data.

(1-8) In the above-described embodiment, a printer section 10 is provided that prints an image on paper according to the image data (data signal) taken in by the ASIC 74. However, a printer section 10 is not absolutely necessary and a standalone scanner is sufficient.

(2-1) The above-described SPC multifunction apparatus is provided with a CCD sensor 44 that detects color information on a pixel-by-pixel basis, a control circuit 51, and an ASIC 74 (main circuit). The control circuit 51 controls the CCD sensor 44 and outputs R data, G data, and B data to data signal lines based on the detection results of the CCD sensor 44 while switching the order of the data according to a modulated clock. The ASIC 74 takes in the respective R data, G data, and B data of each of the pixels from the data signal lines.

Supposing a configuration such as that of the first reference example shown in FIG. 10, the ASIC 74 is synchronized with the operation of the control circuit 51 and therefore is capable of identifying the timing at which the signals outputted from the control circuit 51 are taken in.

However, in the present embodiment, the control circuit 51 is operated on a frequency modulated clock as a countermeasure against electromagnetic noise. On the other hand, the ASIC 74 is operated on a different clock from that of the control circuit 51 and therefore is not synchronized with the operation of the control circuit 51. Thus, when these two boards are operating on separate clocks, there is a possibility of deviation in the timing by which the ASIC 74 takes in signals outputted from the control circuit 51.

Accordingly, in the present embodiment, the control circuit 51 outputs to a clock signal line a take-in clock that is synchronized with the timing by which the R data, G data, and B data are switched. Also, in the present embodiment, the ASIC 74 takes in color data from the data signal line at a timing corresponding to the take-in clock.

However, it is necessary for the ASIC 74 to distinguish which color is represented by the color data being taken in. For example, when the ASIC 74 has taken in 8-bit data from the data signal lines at the take-in timings indicated by dotted lines in FIG. 16, it is necessary to distinguish whether the 8-bit data is R data or G data.

Accordingly, in the present embodiment, the control circuit 51 outputs to the data signal lines a pixel period indication signal that indicates the time period during which the R data, the G data, and the B data for one pixel are outputted. Specifically, as shown in FIG. 18, the control circuit 51 outputs to the data signal lines a pixel period indication signal synchronized with the take-in clock in the order “FF”→“00”→“00”→“FF”→“00”→“00”→ . . . . Also, in the present embodiment, the ASIC 74 can identify the one-pixel period by the pixel period indication signal, and therefore is capable of taking in the first data in the one-pixel period as R data, the next data as G data, and the data after that as B data. Furthermore, the ASIC 74 can take in the data following the B data as the R data of the next pixel.

The pixel period indication signal is outputted using the data signal lines, and therefore the main circuit can take in the respective R data, G data, and B data of each pixel using a simple configuration.

(2-2) In the above-described embodiment, the control circuit 51 is operated according to a frequency modulated clock. Thus, the strength of the electromagnetic noise can be reduced. As a result, however, the switching cycle of the R data, G data, and B data is also modulated, and therefore the timing by which the main circuit takes in the R data, G data, and B data would normally become a problem. However, in the present embodiment, the take-in clock that is synchronized with the timing of the switching of the R data, G data, and B data is also modulated, and therefore there is no deviation in timing as long as the data is taken in from the data signal lines with a timing corresponding to the take-in clock.

It should be noted that the operational clock of the control circuit 51 is modulated in the above-described embodiment, but this is not a limitation. For example, even if the operational clock of the control circuit 51 is not modulated, the ASIC 74 can perceive the timing by which the R data will arrive as long as a configuration in which a pixel period indication signal is outputted from the control circuit 51 to the ASIC 74 is adopted. However, in this case, electromagnetic noise is produced in the vicinity of the CCD sensor.

(2-3) In the foregoing embodiment, an oscillator 53 that generates a reference clock and a PLL circuit 54 that generates a frequency modulated clock corresponding to the reference clock are provided. Also, the oscillator 53 and the PLL circuit 54 are provided on the same CCD board 50 as the control circuit 51 in this embodiment. Thus, there is no need for a signal line for sending the reference clock to the control circuit 51.

(2-4) However, it is not absolutely necessary for the oscillator 53 to be provided on the same board as the control circuit 51. For example, it is also possible that a low frequency reference clock is transmitted from the ASIC 74 to the control circuit 51 and the control circuit 51's PLL circuit, which has an SSCG function, performs multiplication while modulating the reference clock. In this case, although a signal line is necessary for sending the reference clock from the ASIC 74 to the control circuit 51, the oscillator 53 can be omitted, thus enabling costs to be reduced.

(2-5) In the above-described embodiment, the pixel period indication signal and the R data, G data, and B data are outputted using the same data signal lines. For this reason, the output of the image data (R data, G data, and B data) occurs after the output of the pixel period indication signal has been stopped. In the present embodiment, the take-in clock continues to be outputted during the period from when output of the pixel period indication signal is stopped until the image data is outputted. Thus, the ASIC 74 can continue to distinguish the single pixel period and therefore can identify which color is represented by the data when the image data is outputted from the data signal lines.

(2-6) In the above-described embodiment, the ASIC 74 (main circuit) and the control circuit 51 are initially operated based on different clock signals. While in this state, a phase matching signal is outputted from the ASIC 74 to the control circuit 51. When the phase matching signal arrives, the control circuit 51 outputs a pixel period indication signal and the take-in clock to the ASIC 74 and also starts to control the CCD sensor. While the signal level of the phase matching signal is at the H level, the control circuit 51 outputs the pixel period indication signal. Then, when the signal level of the phase matching signal changes to the L level, output of the pixel period indication signal is stopped. However, the control circuit 51 continues to output the take-in clock signal even when output of the pixel period indication signal has been stopped. The control circuit 51 outputs the respective R data, G data, and B data of each of the pixels in order as the detection results of the CCD sensor. The ASIC 74 can identify which image data representing which color is transmitted at which timing, and therefore can take in the respective R data, G data, and B data of each of the pixels.

(2-7) It should be noted that if all the structural elements of the above-described embodiment are included, it is possible to achieve all the effects described above. However, it is not absolutely necessary to have all the structural elements to achieve the effect of the main circuit being able to take in the respective R data, G data, and B data of each of the pixels with a simple configuration.

(2-8) In the above-described embodiment, a printer section is provided that prints an image on paper according to the image data (R data, G data, and B data) taken in by the ASIC 74. However, a printer section 10 is not absolutely necessary and a standalone scanner is sufficient.

What is claimed is:

1. An image reading device comprising:
a CCD sensor for reading an image;
a clock generator that generates a frequency modulated clock;
a control circuit that
operates in accordance with said frequency
modulated clock,
controls said CCD sensor,
outputs a detection result of said CCD sensor as a data signal, and
outputs a take-in clock synchronized with said data signal; and
a main circuit that operates in accordance with a separate clock from said frequency modulated clock, to which said data signal and said take-in clock outputted from said control circuit are inputted, and that takes in said data signal based on said take-in clock.

2. An image reading device according to claim 1,
wherein said clock generator generates said frequency modulated clock in accordance with a reference clock; and
wherein an oscillator that generates said reference clock is provided on a same board as said control circuit.

3. An image reading device according to claim 1,
wherein said clock generator generates said frequency modulated clock in accordance with a reference clock; and
wherein said reference clock is transmitted from said main circuit to said control circuit.

4. An image reading device according to claim 1,
wherein said separate clock by which said main circuit is operated has a higher frequency than said take-in clock; and
wherein said main circuit detects a change in a signal level of said take-in clock and takes in said data signal using, as a reference, a timing at which said signal level of said take-in clock changes.

5. An image reading device according to claim 1,
wherein said control circuit outputs, as said data signal, R data, G data, and B data in order within a predetermined time period; and
wherein, before said control circuit outputs said data signal, said control circuit outputs a signal indicating said predetermined time period using a signal line for outputting said data signal.

6. An image reading device according to claim 5,
wherein said take-in clock is outputted during a period from when said signal indicating said predetermined time period is outputted until said data signal is outputted.

7. An image reading device comprising:
a CCD sensor for reading an image;
a clock generator that generates a frequency modulated clock;
a control circuit that
operates in accordance with said frequency modulated clock,
controls said CCD sensor,
outputs a detection result of said CCD sensor as a data signal, and
outputs a take-in clock synchronized with said data signal; and
a main circuit that operates in accordance with a separate clock from said frequency modulated clock, to which said data signal and said take-in clock outputted from said control circuit are inputted, and that takes in said data signal based on said take-in clock;
wherein said clock generator generates said frequency modulated clock in accordance with a reference clock;
wherein an oscillator that generates said reference clock is provided on a same board as said control circuit;
wherein said separate clock by which said main circuit is operated has a higher frequency than said take-in clock;
wherein said main circuit detects a change in a signal level of said take-in clock and takes in said data signal using, as a reference, a timing at which said signal level of said take-in clock changes;
wherein said control circuit outputs, as said data signal, R data, G data, and B data in order within a predetermined time period;
wherein, before said control circuit outputs said data signal, said control circuit outputs a signal indicating said predetermined time period using a signal line for outputting said data signal; and
wherein said take-in clock is outputted during a period from when said signal indicating said predetermined time period is outputted until said data signal is outputted.

8. A printing apparatus comprising:
a CCD sensor for reading an image;
a clock generator that generates a frequency modulated clock;
a control circuit that
operates in accordance with said frequency modulated clock,
controls said CCD sensor,
outputs a detection result of said CCD sensor as a data signal, and
outputs a take-in clock synchronized with said data signal;
a main circuit that operates in accordance with a separate clock from said frequency modulated clock, to which said data signal and said take-in clock outputted from said control circuit are inputted, and that takes in said data signal based on said take-in clock; and
a printing section that prints said image on a medium based on the data signal that has been taken in by said main circuit.

9. An image reading device comprising:
a CCD sensor that detects color information on a pixel-by-pixel basis;
a control circuit that
operates according to a predetermined clock,
controls said CCD sensor,
switches, in order according to said clock, R data, G data, and B data of each of the pixels based on a detection result of said CCD sensor, and outputs the R data, G data, and B data of each of the pixels to a data signal line, and
outputs, to a clock signal line, a take-in clock synchronized with a timing at which said R data, G data, and B data are switched; and
a main circuit that operates according to a separate clock from said predetermined clock of said control circuit, and that takes in the R data, the G data, and the B data of each of said pixels from said data signal line at a timing corresponding to said take-in clock of said clock signal line;
wherein said control circuit outputs, to said data signal line, an indication signal that indicates a time period in which the R data, the G data, and the B data for a single pixel is outputted; and
wherein said main circuit takes in the R data, the G data, and the B data of each of said pixels at a timing corresponding to said indication signal and said take-in clock.

10. An image reading device according to claim 9,
wherein said control circuit operates according to a frequency modulated clock; and
wherein said R data, G data, and B data and said take-in clock are outputted from said control circuit to said main circuit according to said frequency modulated clock.

11. An image reading device according to claim 10,
wherein said image reading device further comprises an oscillator that generates a reference clock, and a clock generator that generates said frequency modulated clock according to said reference clock; and
wherein said oscillator and said clock generator are provided on a same board as said control circuit.

12. An image reading device according to claim 10,
wherein said image reading device further comprises a clock generator that generates said frequency modulated clock in accordance with a reference clock;
wherein said clock generator is provided on a same board as said control circuit; and
wherein said reference clock is transmitted from said main circuit to said control circuit.

13. An image reading device according to claim 9,
wherein said take-in clock is outputted during a period from when output of said indication signal is stopped until said R data, G data, and B data are outputted.

14. An image reading device according to claim 9,
wherein a phase matching signal is outputted from said main circuit to said control circuit;
wherein said indication signal and said take-in clock are outputted from said control circuit to said main circuit according to said phase matching signal;
wherein said take-in clock is outputted from said control circuit to said main circuit during a period from when output of said indication signal is stopped until said R data, G data, and B data are outputted; and
wherein, in accordance with said phase matching signal, control of said CCD sensor is started and said R data, G data, and B data are outputted from said control circuit to said main circuit.

15. An image reading device comprising:
a CCD sensor that detects color information on a pixel-by-pixel basis;
a control circuit that
operates according to a predetermined clock,
controls said CCD sensor,
switches, in order according to said clock, R data, G data, and B data of each of the pixels based on a detection result of said CCD sensor, and outputs the R data, G data, and B data of each of the pixels to a data signal line, and
outputs, to a clock signal line, a take-in clock synchronized with a timing at which said R data, G data, and B data are switched; and
a main circuit that operates according to a separate clock from said predetermined clock of said control circuit, and that takes in the R data, the G data, and the B data of each of said pixels from said data signal line at a timing corresponding to said take-in clock of said clock signal line;
wherein said control circuit outputs, to said data signal line, an indication signal that indicates a time period in which the R data, the G data, and the B data for a single pixel is outputted;
wherein said main circuit takes in the R data, the G data, and the B data of each of said pixels at a timing corresponding to said indication signal and said take-in clock;
wherein said control circuit operates according to a frequency modulated clock;
wherein said R data, G data, and B data and said take-in clock are outputted from said control circuit to said main circuit according to said frequency modulated clock;
wherein said image reading device further comprises an oscillator that generates a reference clock, and a clock generator that generates said frequency modulated clock according to said reference clock;
wherein said oscillator and said clock generator are provided on a same board as said control circuit;
wherein said take-in clock is outputted during a period from when output of said indication signal is stopped until said R data, G data, and B data are outputted;
wherein a phase matching signal is outputted from said main circuit to said control circuit;
wherein said indication signal and said take-in clock are outputted from said control circuit to said main circuit according to said phase matching signal;
wherein said take-in clock is outputted from said control circuit to said main circuit during a period from when output of said indication signal is stopped until said R data, G data, and B data are outputted; and
wherein, in accordance with said phase matching signal, control of said CCD sensor is started and said R data, G data, and B data are outputted from said control circuit to said main circuit.

16. A printing apparatus comprising:
a CCD sensor that detects color information on a pixel-by-pixel basis;
a control circuit that
operates according to a predetermined clock,
controls said CCD sensor,
switches, in order according to said clock, R data, G data, and B data of each of the pixels based on a detection result of said CCD sensor, and outputs the R data, G data, and B data of each of the pixels to a data signal line, and
outputs, to a clock signal line, a take-in clock synchronized with a timing at which said R data, G data, and B data are switched;
a main circuit that operates according to a separate clock from said predetermined clock of said control circuit, and that takes in the R data, the G data, and the B data of each of said pixels from said data signal line at a timing corresponding to said take-in clock of said clock signal line; and
a printing section that prints, on a medium, an image that has been detected by said CCD sensor, based on said R data, G data, and B data that have been taken in by said main circuit;
wherein said control circuit outputs, to said data signal line, an indication signal that indicates a time period in which the R data, the G data, and the B data for a single pixel is outputted; and
wherein said main circuit takes in the R data, the G data, and the B data of each of said pixels at a timing corresponding to said indication signal and said take-in clock.
